(19) United States
(12) Patent Application Publication
(10) Pub. No.: US 2022/0012034 A1
(43) Pub. Date: Jan. 13, 2022

(54) DRIVER SOFTWARE FOR READING OUTGOING DATA FROM A POINT OF SALE (POS) SYSTEM

(71) Applicant: Roll, Inc, Newport Coast, CA (US)

(72) Inventors: Shounat Dhillon, Newport Coast, CA (US); Sam Ghodrati-Azadi, Glendale, CA (US)

(21) Appl. No.: 17/372,047

(22) Filed: Jul. 9, 2021

Related U.S. Application Data
(60) Provisional application No. 63/050,587, filed on Jul. 10, 2020.

(51) Int. Cl. G06F 8/61; G06Q 20/20

(52) U.S. Cl. CPC G06F 8/61; G06Q 20/202

(57) ABSTRACT

The present invention is directed to driver software for reading data from a POS system and transmitting said data to one or more external sources. The present invention features a driver application that may comprise instructions for accepting data from a POS system, transmitting the data from the POS system to an external device, and transmitting the data to the one or more external sources. The driver application may be used in a method for reading outgoing data from a POS system to be sent to one or more external sources. The method may comprise installing the driver application onto a computing device, entering a transaction into a POS system, transmitting the transaction data to a spooler, and transmitting the transaction data from the spooler to the driver application to be transmitted to an external device and then transmitted to the one or more external sources.

### CROSS-REFERENCES TO RELATED APPLICATIONS

This application is a non-provisional and claims benefit of U.S. Provisional Application No. 63/050,587 filed Jul. 10, 2020, the specification of which is incorporated herein in their entirety by reference.

### FIELD OF THE INVENTION

The present invention is directed to driver software for reading data from a POS system and transmitting said data to an external source.

### BACKGROUND OF THE INVENTION

When it comes to third-party software solutions for restaurants, many are unable to talk to (integrate with) the restaurant's POS (point of sale). If a third-party application requires information/data from the point of sale or wants to send information/data to the point of sale, they are typically unable to do so. The POS is usually a closed system. There are some new point of sale systems that now have open API's and thus allow third parties to send them information. If the POS is an older legacy system, however, there is no integration. For instance, with a food delivery or pick-up application like Postmates or DoorDash, oftentimes their software will sit on a separate tablet next to the POS and that's where the orders come in. The server then has to manually input this order information into the POS. There is no way to get order information out of the POS if that was required, unless the POS company grants you access to their API's. Thus, a present need exists for a way to efficiently extract information from a POS system on both newer and older versions of the POS system.

### BRIEF SUMMARY OF THE INVENTION

It is an objective of the present invention to provide devices and methods that allow for reading data from a POS system and transmitting said data to one or more external sources, as specified in the independent claims. Embodiments of the invention are given in the dependent claims. Embodiments of the present invention can be freely combined with each other if they are not mutually exclusive.

The present invention features a driver application for reading outgoing data from a Point of Sale (POS) system to be sent to one or more external sources. The driver application may comprise instructions for accepting data from a POS system, transmitting the data from the POS system to an external device to be printed, checking for an internet connection on a time interval, and transmitting, upon confirming the internet connection, the data to the one or more external sources through the internet connection. The driver application may be capable of being installed on a computing device. The driver application may further comprise instructions for differentiating between raw data and non-raw data to be transmitted to the external device. Upon failing to confirm the internet connection, the data is stored in a local storage system while an offline module checks for an internet connection on a time interval. The one or more external sources may be a Web API or a software application. The Web API external source may store transaction information in a database.

The present invention features a method for reading outgoing data from a POS system to be sent to one or more external sources. The method may comprise installing a driver application. The driver application may comprise instructions for accepting data from the POS, transmitting the data from the POS system to an external device, and transmitting the data to the one or more external sources. The method may further comprise entering a transaction into the POS system, transmitting transaction data to a spooler, transmitting, by the spooler, the transaction data to the driver application, transmitting, by the driver application, the transaction data to the external device, and transmitting, by the driver application, the transaction data to the one or more external sources. The driver application may further comprise instructions for differentiating between raw data and non-raw data to be transmitted to the external device. Upon failing to confirm the internet connection, the data may be passed into an offline module for checking for the internet connection on the time interval. In some embodiments, the one or more external sources may be a Web API or a software application. The Web API external source may store transaction information in a database.

The software driver of the present invention solves the inability to gather information from the POS. With this driver, third-party software is able to receive order information from the POS. This allows for data transmitted from a POS system in a restaurant to be collected and sent to an external source. In this scenario, a customer could finish eating and have the bill from the restaurant sent to the customer afterwards to be paid later. The payment will be transmitted from the customer to the one or more external sources and then back to the POS system. The driver application of the present invention does not have to interact with APIs or integrate with POS systems, therefore acting as a middleman between the POS and the external device.

One of the unique and inventive technical features of the present invention is the driver application capable of listening to what the POS sends to the external device regardless of the underlying hardware and software of the said POS. Without wishing to limit the invention to any theory or mechanism, it is believed that the technical feature of the present invention advantageously provides for the ability to receive and transmit information from any POS system regardless of version or age. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a schematic of a driver application of the present invention interacting with a POS system, an external device, and one or more external sources.

FIG. 2 shows a flow chart of an embodiment of the driver application of the present invention.

FIG. 3 shows an alternate flow chart of an embodiment of the driver application of the present invention.

FIG. 4 shows a second alternate flow chart of an embodiment of the driver application of the present invention.

### DETAILED DESCRIPTION OF THE INVENTION

Following is a list of elements corresponding to a particular element referred to herein:

100 computing device

200 POS system

300 driver application

400 external device

500 one or more external sources

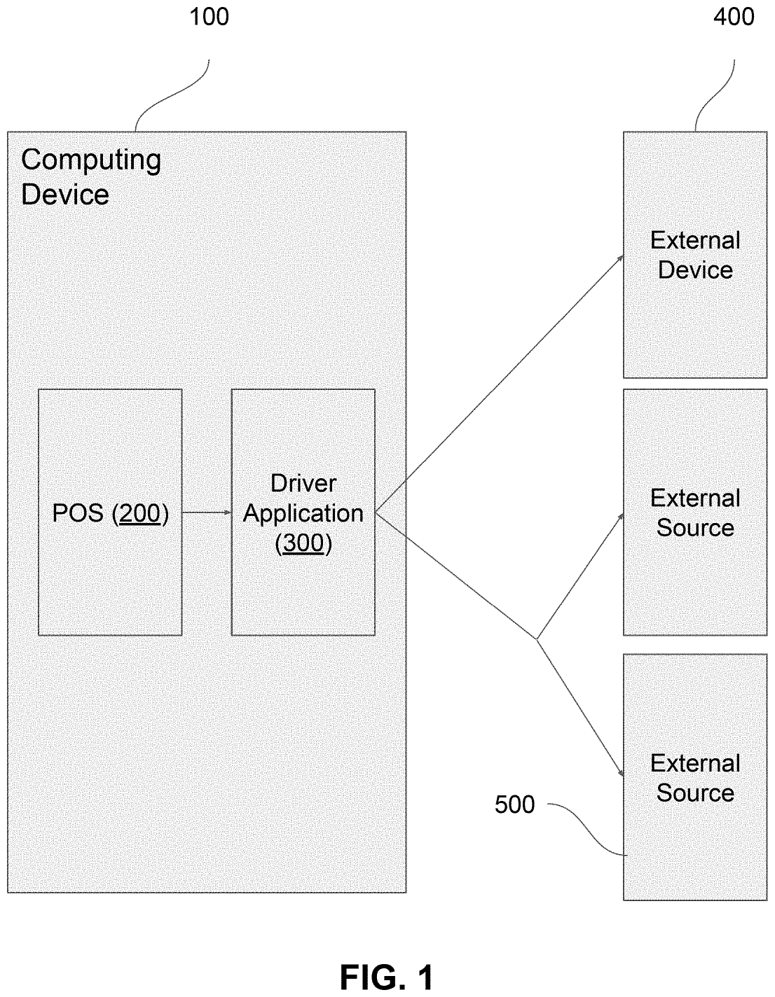

Referring now to FIG. 1, the present invention features a driver application (300) for reading outgoing data from a Point of Sale (POS) system to be sent to one or more external sources (500). The driver application (300) may be capable of accepting data from any POS system regardless of the underlying hardware and software of the said POS system. In some embodiments, the driver application (300) may comprise instructions for accepting data from a POS system (200), transmitting the data from the POS system (200) to an external device (400) to be printed, checking for an Internet connection on a time interval, and transmitting, upon confirming the Internet connection, the data to the one or more external sources (500) through the internet connection. The driver application (300) may be capable of being installed on a computing device (100). In some embodiments, the data is received from a spooler. In some embodiments, the driver application (300) may further comprise instructions for differentiating between raw data and non-raw data to be transmitted to the external device (400). The driver application (300) may further comprise instructions for extracting graphical data from the non-raw data and transmitting the graphical data to the external device (400). In some embodiments, upon failing to confirm the internet connection, the data is passed into an offline module. The offline module may comprise instructions for checking for the internet connection on the time interval. The time interval may be 10 to 20 seconds. The one or more external sources (500) may comprise a Web API, a software application, and/or a cloud server. In some embodiments, the external device (400) may be selected from a group comprising a physical printer, a computer monitor, and a computing device.

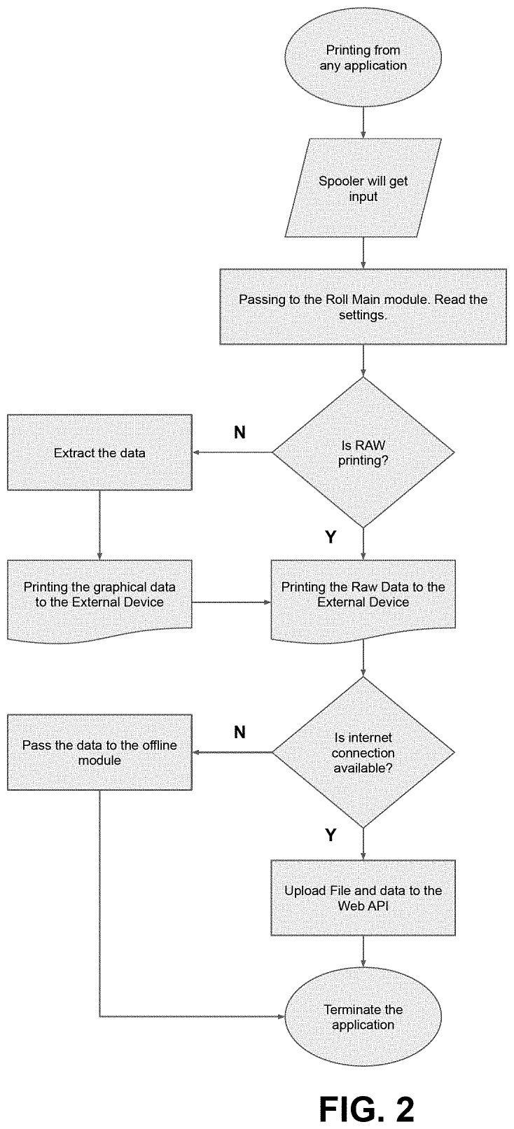

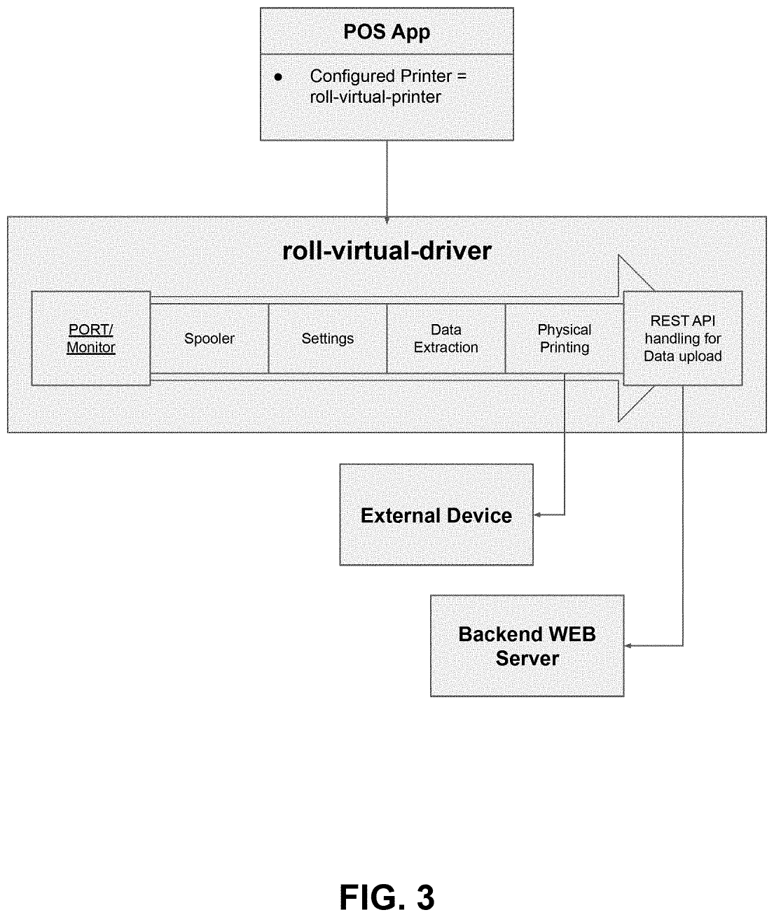

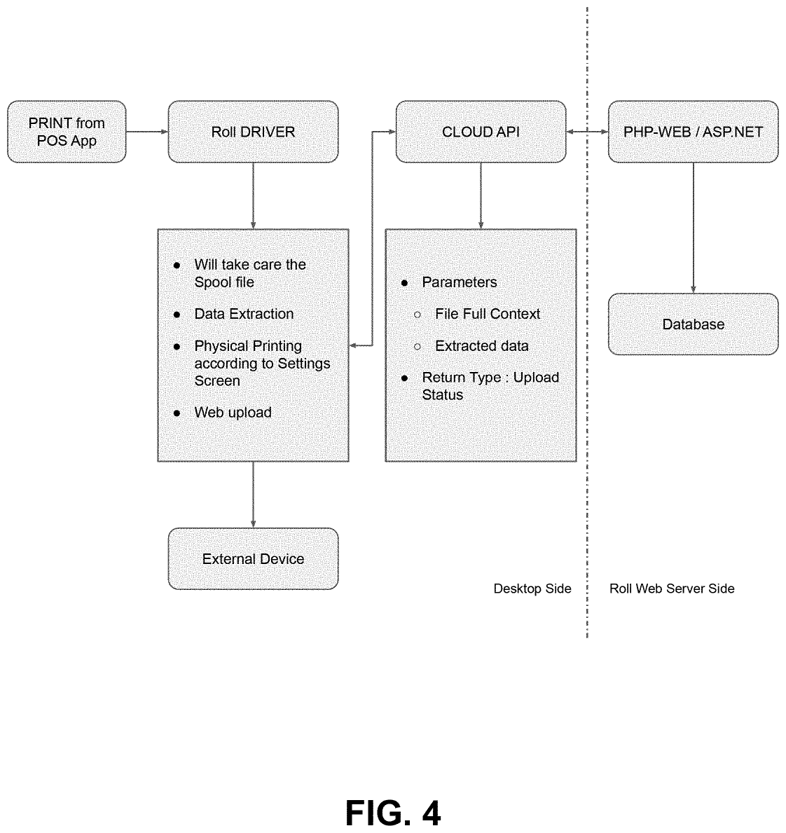

Referring now to FIG. 2-4, the present invention features a method for reading outgoing data from a POS system (200) to be sent to one or more external sources (500). In some embodiments, the method may comprise installing a driver application (300). The driver application (300) may be capable of accepting data from any POS system regardless of the underlying hardware and software of the said POS system. The driver application (300) may comprise instructions for accepting data from the POS, transmitting the data from the POS system (200) to an external device (400), and transmitting the data to the one or more external sources (500). The method may further comprise entering a transaction into the POS system (200), transmitting transaction data to a spooler, transmitting, by the spooler, the transaction data to the driver application (300), transmitting, by the driver application (300), the transaction data to the external device (400), and transmitting, by the driver application (300), the transaction data to the one or more external sources (500). In some embodiments, the method may further comprise reading print settings before transmitting the transaction data to the external device (400). In some embodiments, the driver application (300) may further comprise instructions for differentiating between raw data and non-raw data to be transmitted to the external device (400). The driver application (300) may further comprise instructions for extracting graphical data from the non-raw data and transmitting the graphical data to the external device (400). In some embodiments, upon failing to confirm the Internet connection, the data may be passed into an offline module. The offline module may comprise instructions for checking for the Internet connection on the time interval. The time interval may be 10 to 20 seconds. In some embodiments, the one or more external sources (500) may comprise a Web API, a software application, and/or a cloud server. The Web API external source (500) may be in a PHP-WEB or ASP.NET format and may store transaction information in a database. In some embodiments, the external device (400) may be selected from a group comprising a physical printer, a computer monitor, and a computing device.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A driver application (300) for reading outgoing data from a Point of Sale (POS) system to be sent to one or more external sources (500), wherein the driver application (300) is capable of accepting data from any POS system, the driver application (300) comprising instructions for:
a. accepting data from a POS system (200);
b. transmitting the data from the POS system (200) to an external device (400) to be printed;
c. checking for an internet connection on a time interval; and
d. transmitting, upon confirming the internet connection, the data to the one or more external sources (500) through the internet connection;
wherein the driver application (300) is capable of being installed on a computing device (100).

2. The driver application (300) of claim 1, wherein the data is received from a spooler.

3. The driver application (300) of claim 1 further comprising instructions for differentiating between raw data and non-raw data to be transmitted to the external device (400).

4. The driver application (300) of claim 3 further comprising instructions for extracting graphical data from the non-raw data and transmitting the graphical data to the external device (400).

5. The driver application (300) of claim 4, wherein, upon failing to confirm the internet connection, the data is passed into an offline module, wherein the offline module comprises instructions for checking for the internet connection on the time interval.

6. The driver application (300) of claim 1, wherein the time interval is 10 to 20 seconds.

7. The driver application (300) of claim 1, wherein the one or more external sources (500) comprise a Web API.

8. The driver application (300) of claim 1, wherein the one or more external sources (500) comprise a software application.

9. The driver application (300) of claim 1, wherein the one or more external sources (500) comprise a cloud server.

10. The driver application (300) of claim 1, wherein the external device (400) is selected from a group comprising a physical printer, a computer monitor, and a computing device.

11. A method for reading outgoing data from a POS system (200) to be sent to one or more external sources (500), the method comprising:
a. installing a driver application (300), wherein the driver application (300) is capable of accepting data from any POS system, wherein the driver application (300) comprises instructions for:
i. accepting data from the POS,
ii. transmitting the data from the POS system (200) to an external device (400), and
iii. transmitting the data to the one or more external sources (500);
b. entering a transaction into the POS system (200);
c. transmitting transaction data to a spooler;
d. transmitting, by the spooler, the transaction data to the driver application (300);
e. transmitting, by the driver application (300), the transaction data from the POS system (200) to the external device (400); and
f. transmitting, by the driver application (300), the transaction data to the one or more external sources (500).

12. The method of claim 11, wherein the driver application (300) further comprises instructions for differentiating between raw data and non-raw data to be transmitted to the external device (400).

13. The method of claim 12, wherein the driver application (300) further comprises instructions for extracting graphical data from the non-raw data and transmitting the graphical data to the external device (400).

14. The method of claim 11, wherein, upon failing to confirm the internet connection, the data is passed into an offline module, wherein the offline module comprises instructions for checking for the internet connection on the time interval.

15. The method of claim 11, wherein the time interval is 10 to 20 seconds.

16. The method of claim 11, wherein the one or more external sources (500) comprises a Web API.

17. The method of claim 11, wherein the one or more external sources (500) comprises a software application.

18. The method of claim 11, wherein the external device (400) is selected from a group comprising a physical printer, a computer monitor, and a computing device.

19. The method of claim 11, wherein the one or more external sources (500) comprise a cloud server.
